(19) United States
(12) Patent Application Publication
(10) Pub. No.: US 2011/0298988 A1
(43) Pub. Date: Dec. 8, 2011

(54) MOVING OBJECT DETECTION APPARATUS AND MOVING OBJECT DETECTION METHOD

(75) Inventor: KIYOYUKI KAWAI, FUKUSHIMA-KEN (JP)

(73) Assignee: TOSHIBA ALPINE AUTOMOTIVE TECHNOLOGY CORPORATION, IWAKI-SHI (JP)

(21) Appl. No.: 13/094,345

(22) Filed: Apr. 26, 2011

(30) Foreign Application Priority Data
Jun. 4, 2010 (JP) 2010-128947
Jun. 18, 2010 (JP) 2010-139543

(51) Int. Cl. H04N 5/14

(52) U.S. Cl. 348/699; 348/E05.066

(57) ABSTRACT

An apparatus for detecting a moving object includes: an image input unit that inputs a camera image; a motion vector generation unit that generates motion vectors of a plurality of points P in the image; an estimation unit that estimates rotational components of vehicle movement parameters as being equal to the inclination from each point P to a vanishing point when the inclination of the motion vector of each point P is corrected by the rotational components; and a determination unit that corrects the inclination of the motion vector of a given point Q in the image, and detects the existence of a moving object that moves in a direction different from the vehicle movement direction when the coincidence degree between the inclinations is low, while detects the existence of an object that radially moves toward the vanishing point when the coincidence degree of the inclinations is high.

### CROSS-REFERENCE TO RELATED APPLICATIONS

This application is based upon and claims the benefit of priority from the prior Japanese Patent Applications No. 2010-128947 filed on Jun. 4, 2010 and No. 2010-139543 filed on Jun. 18, 2010, the entire contents of which are incorporated herein by reference.

### FIELD

Embodiments described herein relate generally to a moving object detection apparatus and a moving object detection method that photograph images around a vehicle using cameras mounted on the vehicle and process the obtained camera images so as to detect a moving object.

### BACKGROUND

There is conventionally known an on-vehicle image display device that uses a plurality of cameras mounted on a vehicle to take images of front, rear, or side area surrounding the vehicle so as to detect a moving body based on the obtained images and display an approaching moving object.

In a conventional on-vehicle moving object detection apparatus, a camera itself moves, so that even if an object appearing in the camera is a stationary object, the image contains motion. Thus, it is difficult to judge whether a target object is a moving object or a stationary object with high reliability. There may be a case where although a moving object can be detected in a specific scene, it cannot be detected in another scene.

There is known an example in which a fish-eye camera or the like is used as a camera constituting an image forming unit to take a wide-field image.

### BRIEF DESCRIPTION OF THE DRAWINGS

FIG. 1 is a block diagram illustrating a configuration of a moving object detection apparatus according to a first embodiment of the present invention;

FIG. 2 is a block diagram illustrating a detailed configuration of a moving object detection unit in the first embodiment;

FIG. 3 is a flowchart for explaining operation of the moving object detection apparatus according to the first embodiment;

FIG. 4 is an explanatory view illustrating an example of an image area selected by an image area selection unit;

FIG. 5 is an explanatory view illustrating a coordinate system related to motion vector generation processing;

FIG. 6 is a histogram for selecting a rotation component Ry;

FIG. 7 is an explanatory view illustrating operation of a z0 setting unit;

FIG. 8 is an explanatory view illustrating an example of a motion vector after correction of rotational component;

FIG. 9 is an explanatory view illustrating another example of a motion vector after correction of rotational component;

FIG. 10 is a block diagram illustrating a configuration of the moving object detection apparatus according to a second embodiment;

FIG. 11 is a block diagram illustrating a detailed configuration of the moving object detection unit;

FIG. 12 is an explanatory view schematically illustrating an image taken by a fish-eye camera;

FIG. 13 is an explanatory view for explaining operation of a division/conversion unit;

FIG. 14 is an explanatory view illustrating a pin-hole camera model;

FIG. 15 is an explanatory view for explaining operation of a moving object determination unit; and

FIG. 16 is an explanatory view for explaining operation of the moving object detection apparatus according to the fourth embodiment.

### DETAILED DESCRIPTION

According to one embodiment, an apparatus for detecting a moving object includes: an image input unit that inputs a camera image taken by an on-vehicle camera; a motion vector generation unit that processes the image from the image input unit to generate motion vectors of a plurality of points P in the image; an estimation unit that estimates rotational components (Rx, Ry, Rz) of vehicle movement parameters as being equal to the inclination from each point P to a vanishing point when the inclination of the motion vector of each point P is corrected by the rotational components (Rx, Ry, Rz) of the vehicle movement parameters; and a determination unit that corrects the inclination of the motion vector of a given point Q in the image by using the rotational components (Rx, Ry, Rz) of the vehicle movement parameters, compares the corrected inclination of the motion vector and inclination of a straight line connecting the given point Q and the vanishing point, and detects the existence of a moving object that moves in a direction different from the vehicle movement direction when the coincidence degree between the inclinations is low, while detects the existence of a stationary object or a moving object that radially moves toward the vanishing point when the coincidence degree of the inclinations is high.

Embodiments of the present invention will be described below with reference to the accompanying drawings.

### First Embodiment

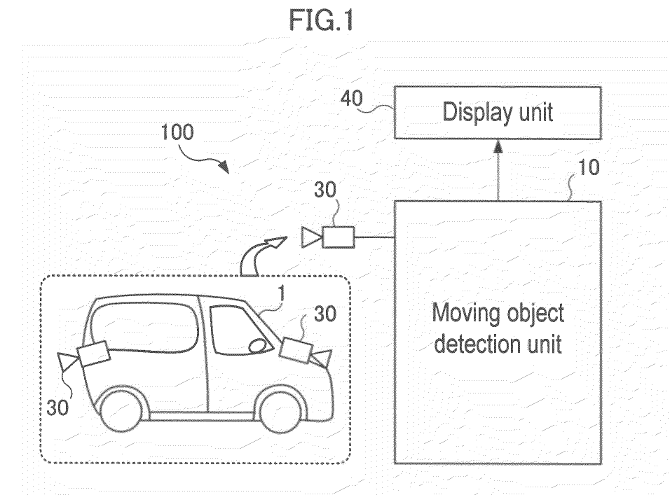

FIG. 1 is a block diagram illustrating a configuration of a moving object detection apparatus 100 according to a first embodiment of the present invention. In FIG. 1, a moving object detection unit 10 processes images taken using a camera 30 mounted on a vehicle 1 to detect a moving object and displays the detection result on a display unit 40. The camera 30 is mounted on the vehicle 1 and takes images around the vehicle 1. FIG. 1 illustrates an example in which a plurality of cameras 30 are mounted on the vehicle 1, each of which is disposed on the front side, rear side, or the like of the vehicle 1.

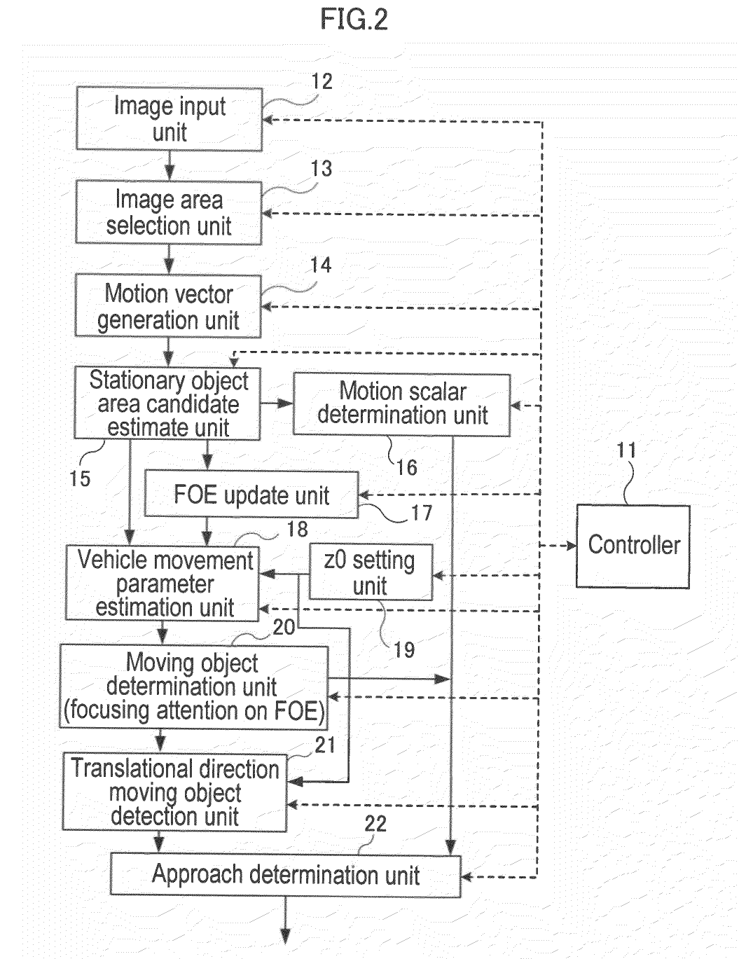

FIG. 2 is a block diagram illustrating a detailed configuration of the moving object detection unit 10. The moving object detection unit 10 includes a controller 11 that controls operation of the moving object detection unit 10, an image input unit 12 that inputs a camera image, an image area selection unit 13 that selects an image area having image information effective for moving object detection processing, and a motion vector generation unit 14 that generates a motion vector of the image area selected by the image area selection unit 13.

The moving object detection unit 10 further includes a stationary object area candidate estimate unit 15 that estimates a stationary object candidate from the image (image containing both stationary and moving objects) selected by the image area selection unit 13, a motion scalar determination unit 16 that regards the image in which no stationary area candidate is found as whole-screen-moving or whole-screen-stationary and determines an area in which motion occurs as a moving object, and an FOE update unit 17 that calculates FOE (Focus of Expansion) when a vehicle mounting the cameras moves without rotating for update.

The moving object detection unit 10 further includes a vehicle movement parameter estimation unit 18 that estimates vehicle movement parameters (including rotational components Qu, Qv and translational components Tx, Ty, and Tz) based on an image within the area estimated by the stationary object area candidate estimate unit 15 and a z0 setting unit 19 that sets an estimated distance weighting coefficient z0 as an approximate distance for estimating the translational components (Tz, Tx, Ty).

The moving object detection unit 10 further includes a moving object determination unit 20 that focuses attention on the FOE, a translational direction moving object detection unit 21 that detects a moving object radially moving toward the FOE, an approach determination unit 22 that inputs thereto information of the moving object determined by the motion scalar determination unit 16, information of the moving object detected by the moving object determination unit 20, and information of the moving object detected by the translational direction moving object detection unit 21 and determines the existence of a moving object based on the logical OR of the above information.

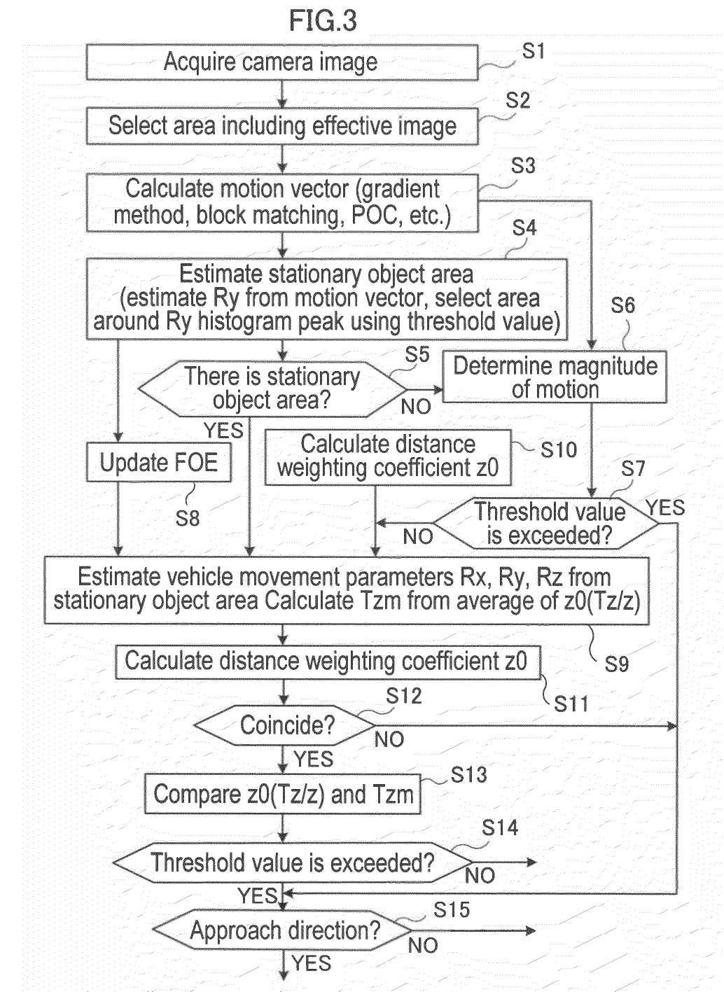

FIG. 3 is a flowchart for explaining operation of the moving object detection apparatus according to the first embodiment of the present invention and, hereinafter, the operation will be described with reference to related drawings. The moving object detection unit 10 operates under the control of the controller 11, and the controller 11 is a microprocessor including a CPU, a ROM, a RAM, and the like. The controller 11 generates a control signal to each block so as to achieve the following operations (in FIG. 2, control signal lines are indicated by dotted arrows).

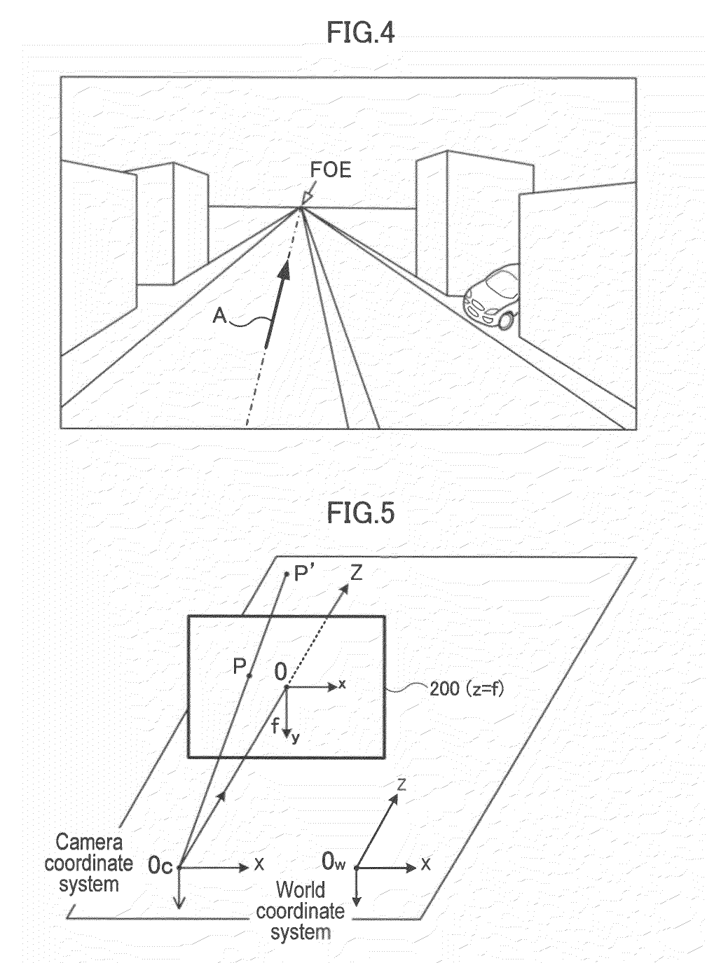

In step S1, a camera image taken by the camera 30 is acquired through the image input unit 12. In step S2, an image area having image information effective for subsequent motion vector calculation processing is selected by the image area selection unit 13. As a determination method of the effective image information, a feature point extraction method can be used. From the extracted feature point, the motion vector can unambiguously calculated. As illustrated in FIG. 4, the ground that spreads infinitely in the image converges to a given line, which is referred to as “vanishing line”. When a vehicle mounting the cameras moves without rotating (for example, moves in the direction indicated by an arrow A), a point at which extended motion vectors obtained by extending a plurality of motion vectors in the image converge is the vanishing point (FOE).

In step S3, the motion vector generation unit 14 generates a motion vector of the area selected by the image area selection unit 13. As the motion vector generation processing, a block matching method or the like can be used.

For example, as illustrated in FIG. 5, an xyz coordinate system is defined as a camera coordinate system, in which the optical axis of the camera 30 is set to z-axis, axis parallel to the road surface is set to x-axis, and axis on the plane perpendicular to the road surface is set to y-axis. When the camera center is set as Oc (0,0,0) and focal length is set as f, a projected plane in which z=f (f is focal length) is represented by 200, and point P′ of the world coordinate is projected on a point P of the projected plane 200. Further, a coordinate system fixed to the ground of the world coordinate system is represented as Ow.

The motion vector V (u,v) of the P (x,y) on the screen corresponding to the movement of the vehicle can be represented by the following known expressions (1) and (2).

[Numeral 1]

u=Ωu+x(T_{z}|z)−f(Tₓ/z) (1)

v=Ωv+y(T_{z}/z)−f(T_{y}/z) (2)

In the expressions (1) and (2), rotational components Ωu, Ωv and translational components Tx, Ty, Tz are used as vehicle movement parameters, and Tx, Ty, and Tz represent the translational speeds in the x-axis direction, y-axis direction, and z-axis direction, respectively. Further, Ωu and Ωv are represented using Rx, Ry, and Rz according to the following expressions (3) and (4). Rx, Ry, and Rz represent rotational components around the x-axis, y-axis, and z-axis, respectively.

[Numeral 2]

Ωu=(xyf)Rx−(f²+x²)(1/f)R_{y}+yR_{z} (3)

Ωv=(f²+y²)(1/f)Rₓ−xy/fR_{y}−xR_{z} (4)

As is known, when an inclination is calculated after applying rotational component-based correction to the motion vector V (u,v) at the point P (x,y), the same inclination as that from the P (x,y) to FOE is obtained. That is, the following expression (5) is established.

$$\begin{matrix}[ Numeral 3 ] & \\ \frac{u - Ω u}{v - Ω v} = \frac{x - x 0}{y - y 0} & ( 5 )\end{matrix}$$

The stationary object area candidate estimate unit 15 receives as an input the image (image containing both stationary and moving objects) selected by the image area selection unit 13 and performs, in step S4, estimation of a stationary object area. That is, in the case of the on-vehicle camera, values of Rx and Rz are often quite small, so that when approximation of:

Rx=Rz=0

is performed, the following expressions (6) and (7) are obtained.

[Numeral 4]

Ωu=−(f²+x²)R_{y} (6)

Ωv=−(xy/f)R_{y} (7)

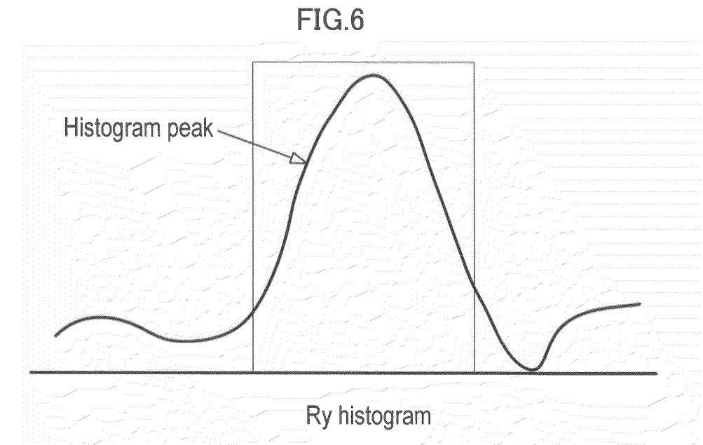

Based on the above expressions (5), (6), and (7), Ry can be calculated for each pixel P from the point P (x,y), motion vector V (v,u), and FOE (x0, y0). For a stationary object, the common Ry is obtained. The plurality of Rys are calculated for a plurality of image points, a histogram of the Ry as illustrated in FIG. 6 is generated, and an area near the peak of the histogram having the common Ry is selected as a stationary object area candidate.

However, it is preferable to take into account that the Rz is generated when the vehicle speed is high. In this case, approximation of:

Rx=0

is performed, the following expressions (8) and (9) are obtained.

[Numeral 5]

Ωu=−(f²+x²)(1/f)R_{y}+yR_{z} (8)

Ωv=−(xy|f)R_{y}−xR_{z} (9)

Ry and Rz can be calculated from the plurality of adjacent motion vectors. In this case, histograms of Ry and Rz are generated, and areas near the peaks of the histograms having the common Ry and common Rz are respectively selected as stationary object area candidates.

In the case where no stationary area candidate can be found (No in step S5), the input image is regarded as whole-screen-moving or whole-screen-stationary and an area in which motion occurs is determined as a moving object by the motion scalar determination unit 16. That is, the motion scalar determination unit 16 determines the magnitude (scalar quantity) of the motion in a target area in step S6 and determines the target area as the motion area when the scalar quantity exceeds a preset threshold value (YES in step S7). The vector quantity is represented by direction and magnitude, and only the magnitude is referred to as scalar or scalar quantity. Even in the case where there is a little stationary object area on the screen, when the peak of the Ry histogram corresponding to the stationary object area can be found, the found area can be determined as the stationary object area.

In step S8, when the vehicle moves without rotating, the FOE update unit 17 calculates the FOE as an intersection of extended motion vectors for update. It seems that the vanishing point (FOE) does not change since translational movement occurs only in the vehicle central axis direction in the case of the on-vehicle cameras. However, in the case where the number of passengers is large or carried load is heavy, or where the installation position of the camera 30 is changed due to aging, optical axis deviation may occur. The deviation of the optical axis of the camera 30 develops as deviation of the vanishing point (FOE). Therefore, in step S8, update of the FOE is performed.

That is, it is assumed within the stationary object area candidate that when rotational component=0 is established, the motion vector of the point P (x,y) is (un,vn). Assuming that a point on the extended line of the motion vector starting from the point P is (x0,y0) under this condition, the following expression (10) can be obtained.

[Numeral 6]

(1/un)x0+(1/vn)=xn/un+yn/vn (10)

When n points P are expressed in a matrix form, the following expression (11) can be obtained.

$$\begin{matrix}[ Numeral 7 ] & \\ ( \begin{matrix}… \\ \begin{matrix}1 / {u}_{n} & 1 / {v}_{n}\end{matrix} \\ …\end{matrix} ) ( \begin{matrix}{x}_{0} \\ {y}_{0}\end{matrix} ) = ( \begin{matrix}… \\ xn / un + yn / vn \\ …\end{matrix} ) & ( 11 )\end{matrix}$$

Then, from the plurality of points P, a vanishing point (x0,y0) is calculated using a method of least squares, and the obtained result is used as a new vanishing point. Thus, update of the vanishing point occurs only while the vehicle is translating; however, this poses no problem since a variation in the vanishing point does not occur frequently. Further, installation angle of the camera 30 can be calculated from the vanishing point, so that the vanishing point update data is sent, as calibration data, to the z0 setting unit 19 to be described later.

Under the condition that the optical axis of the camera 30 faces downward with respect to the road surface at a depression angle of θ, when vehicle translational speed is T, translational speeds Tz and Ty in the z-axis and y-axis directions are T cos θ and T sin θ, respectively. The vanishing point (x0,y0) can be represented as x0=fTx/Tz, y0=fTy/Tz, so that y0=f·tan θ is satisfied and thus the camera depression angle can be calculated from the vanishing point. Similarly, in terms of the x-axis direction, an angle φ formed by the vehicle center line and optical axis can be calculated by x0=f·tan φ.

In step S9, the vehicle movement parameter estimation unit 18 uses the motion vectors V (un,vn) of n points P (xn,yn) within the stationary object area selected by the stationary object area candidate estimate unit 15 to estimate vehicle movement parameters Rx, Ry, and Rz. That is, the following expression can be obtained from the above expressions (1), (2), (3), and (4).

$$\begin{matrix} [ Numeral 8 ] & \\ If assuming that \\ {a}_{n} = ( {y}_{n} - {y}_{0} ) / ( {x}_{n} / {x}_{0} ) , \\ ( \begin{matrix}{a}_{n} {x}_{1} {y}_{1} - ( {x}_{1}^{2} + {f}^{2} ) & - {a}_{n} ( {y}_{1}^{2} + {f}^{2} ) + {x}_{1} {y}_{1} & f ( {a}_{n} {y}_{1} + {x}_{1} ) \\ & … & \\ & … & \\ {a}_{n} {x}_{n} {y}_{n} - ( {x}_{n}^{2} + {f}^{2} ) & - {a}_{n} ( {y}_{n}^{2} + {f}^{2} ) + {x}_{n} {y}_{n} & f ( {a}_{n} {y}_{n} + {x}_{n} )\end{matrix} ) ( \begin{matrix}{R}_{x} \\ {R}_{y} \\ {R}_{z }\end{matrix} ) = ( \begin{matrix}f ( {a}_{n} {u}_{1} - {v}_{1} ) \\ ⋮ \\ f ( {a}_{n} {u}_{n} - {v}_{n} )\end{matrix} ) & \begin{matrix} \\ ( 12 )\end{matrix}\end{matrix}$$

From the expression (12), the rotational components Rx, Ry, and Rz of the vehicle movement parameters are estimated by a method of least squares using singular value decomposition. Translational components obtained from the expressions (1) to (4) using the estimated rotational components are multiplied by the inverse number of the distance z up to an object and calculated only in the forms of Tx/z, Ty/z, and Tx/z. In step S10, the z0 setting unit 19 sets an estimated distance weighting coefficient z0 as an approximate distance for estimating the translational speeds Tz, Tx, and Ty in the x-axis, y-axis, and z-axis directions.

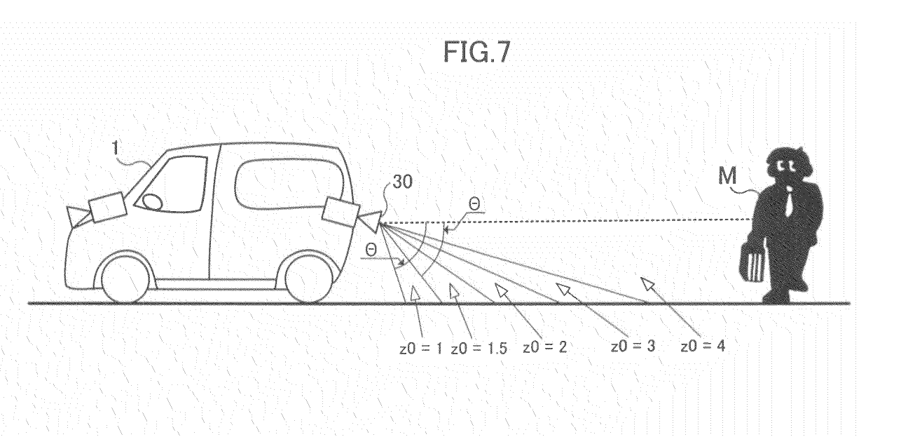

That is, as illustrated in FIG. 7, the coefficient z0 is set in association with the camera viewing angle (depression angle θ) corresponding to the distance from the camera 30 to the road surface. In the example of FIG. 7, z0 is set to 1 for an image with a viewing angle corresponding to the camera-to-road surface distance of 1 m to 1.5 m. Similarly, z0 is set to 1.5 for an image with a viewing angle corresponding to the camera-to-road surface distance of 1.5 m to 2 m, z0 is set to 2 for an image with a viewing angle corresponding to the camera-to-road surface distance of 2 m to 3 m, and z0 is set to 3 for an image with a viewing angle corresponding to the camera-to-road surface distance of 3 m to 4 m, and z0 is set to 4 for an image with a viewing angle corresponding to the camera-to-road surface distance of 4 m to infinite. Once the angle θ is known, the distance from the vehicle to an object M can be calculated.

The camera viewing angle and each pixel on the camera image one-to-one correspond to each other. Therefore, the estimated distance weighting coefficient z0 that associates the road surface with camera viewing angle may previously be calculated for each pixel and set in an LUT (look up table), etc.

Although a procedure of previously setting the z0 in a discrete manner has been described in FIG. 7, the z0 may be set to 1/z and continuously be associated with the camera viewing angle. In this case, the z0 is set to a fixed value in the range not less than z since there is a limit to the camera resolution power.

After the distance z0 has been set in association with the camera viewing angle corresponding to the camera-to-road surface distance as described above, the vehicle movement parameter estimation unit 18 calculates Tz=z0 (.Tz/z), Tx=z0 (.Tx/z), and Ty=z0 (.Ty/z) and then calculates an average among a plurality of points to calculate the estimated translational components Tzm, Tym, and Txm.

Meanwhile, the moving object determination unit 20 that focuses attention on the FOE performs the following processing in step S11. That is, the moving object determination unit 20 assigns the vehicle movement parameters Rx, Ry, and Rz to the expressions (1) to (4) to calculate the inclination after motion compensation, i.e., expression (13) for an arbitrary point Q (x,y) within the image.

$$\begin{matrix}[ Numeral 9 ] & \\ \frac{u - Ω u}{v - Ω v} & ( 13 )\end{matrix}$$

The inclination of a straight line extending from Q (x,y) to FOE (x0, y0) is represented by the following expression (14).

$$\begin{matrix}[ Numeral 10 ] & \\ \frac{x - x 0}{y - y 0} & ( 14 )\end{matrix}$$

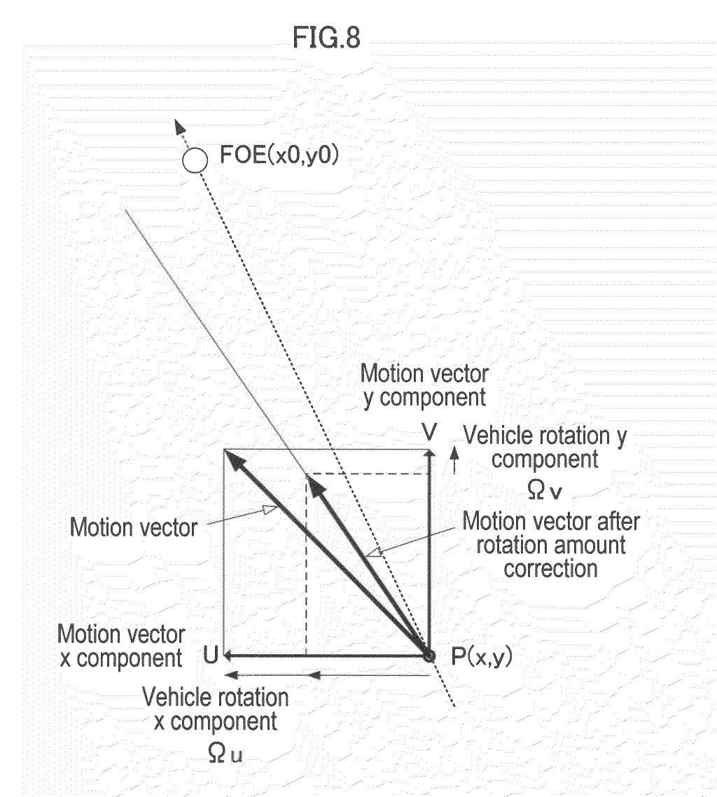

When the coincidence degree is low (NO in step S12) as a result of the comparison between the inclinations (13) and (14) in step S11, the extended line of the motion vector after rotation amount correction (motion vector corrected with rotation components Ωu and Ωv) does not pass through the FOE as illustrated in FIG. 8. In this case, the existence of a moving object that moves in a direction different from the vehicle movement direction is determined.

A camera shake component appears as the vehicle rotational components Rx and Rz. However, as illustrated in the expression (13), the determination is made after the rotation amount correction, allowing the shake occurring when the vehicle drives on a gravel road or uneven road to be corrected if the vehicle rotational components (mainly, Rx and Rz) occur and, thus, the influence of the vehicle shake can be ignored.

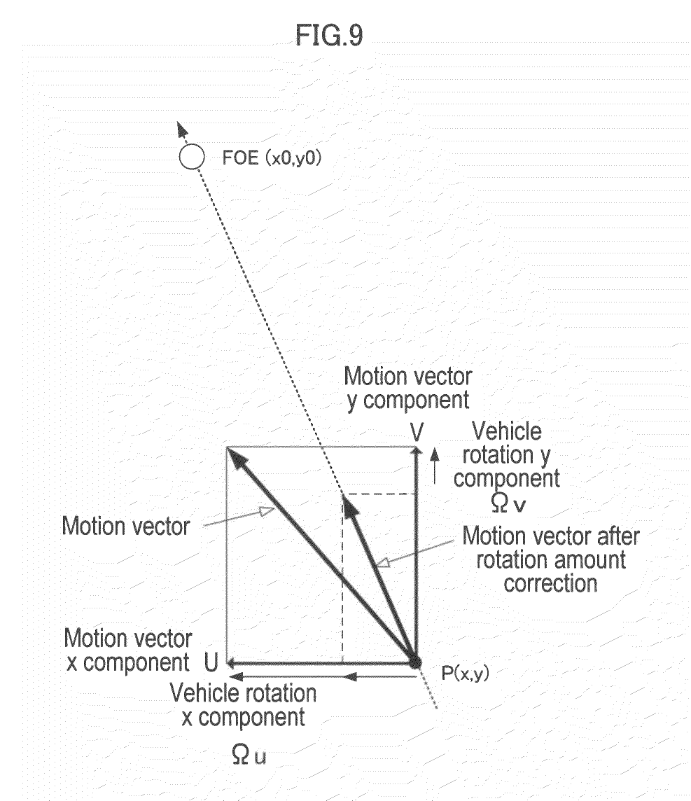

When the coincidence degree is high (YES in step S12) as a result of the comparison between the inclinations (13) and (14), the extended line of the motion vector after rotation amount correction passes through the FOE as illustrated in FIG. 9. In this case, there is a possibility that not only a stationary object but also a moving object radially moving from the FOE exist. Then, the translational direction moving object detection unit 21 performs the following operation.

The translational direction moving object detection unit 21 receives, as an input, information indicating that no moving object has been detected by the moving object determination unit 20 that focuses attention on the FOE and estimated vehicle translational component Tzm obtained in the vehicle movement parameter estimation unit 18. In step S13, the translational direction moving object detection unit 21 calculates Tz/z of the point Q (x,y) from the expressions (1) to (4) and rotational components Rx, Ry, and Rz and compares z0 (Tz/z) and average estimated vehicle translational component Tzm. Then, when the correspondence degree between the z0 (Tz/z) and average estimated vehicle translational component Tzm exceeds a preset threshold value in step S14, the existence of a moving object is determined. That is, an object that moves faster than those around it is determined to be a moving object that moves toward the vehicle.

Further, as is clear from the expressions (1) to (4), when the distance is large, (z is large), the translational component Tz/z becomes small, so that the motion vector becomes small; while when the distance is small, (z is small), the translational component Tz/z becomes large, so that the motion vector becomes large. Therefore, it is difficult to detect a moving object in a long distance, and it is easy to falsely detect a stationary object in a short distance. However, the introduction of the estimated distance weighting coefficient z0 allows easy detection of a moving object in a long distance and reduces false detection of a stationary object in a short distance.

In step S15, the approach determination unit receives, as an input, information (determination result in step S7) of the moving object determined by the motion scalar determination unit 16, information (determination result in step S12) of the moving object determined by the moving object determination unit 20 that focuses attention on the FOE, and information (determination result in step S14) of the moving object determined by the translational direction moving object detection unit 21 and calculates the logical OR of three information for determination of the existence of a moving object. The motion vector direction of an object that has been determined to be the moving object is known. Thus, the approaching direction of the moving object is determined, and a moving object having a direction toward the vehicle is preferentially output as a high-dangerous object. When there is a moving object that is approaching the vehicle, an alarm is displayed in the display unit 40.

As described above, in the first embodiment, a moving object that moves in the direction toward the FOE can be detected and thus a moving object that moves in all directions can be detected. Further, even in the case where the number of passengers is large or carried load is heavy, detection of a moving object can stably be achieved. Further, detection of a moving object can stably be achieved without being influenced by the vehicle shake (camera shake) occurring when, for example, the vehicle drives on a gravel road.

### Second Embodiment

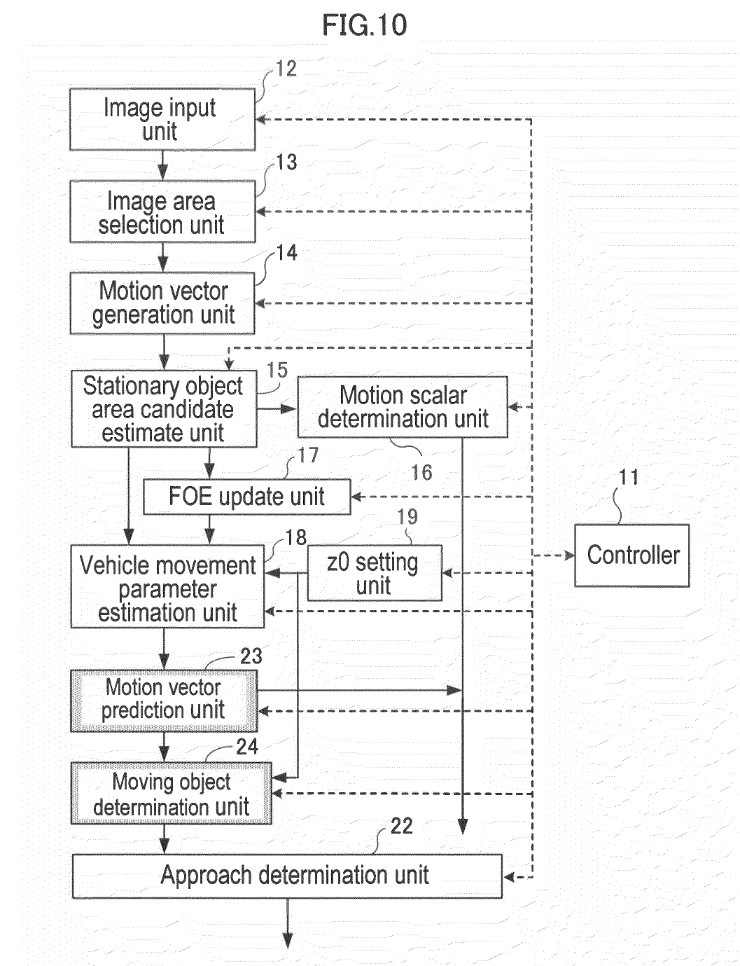

The moving object detection apparatus according to a second embodiment will next be described with reference to FIG. 10. In the second embodiment, the moving object determination unit 20 that focuses attention on the FOE is replaced by a motion vector prediction unit 23, and translational direction moving object detection unit 21 is replaced by a moving object determination unit 24.

As in the first embodiment, the vehicle movement parameter estimation unit 18 outputs the rotational components Rx, Ry, Rz, and average translational components Tzm, Txm, Tym. The motion vector prediction unit 23 uses Tzm/z0, Txm/z0, and Tym/z0 in place of the Tz/z, Tx/z, and Ty/z to calculate prediction vector (u′,v′) from the motion vector of the point Q (x,y) based on the expressions (1) to (4).

The moving object determination unit 24 compares the actual measurement motion vector (u,v) and prediction motion vector (u′,v′) and, when the coincidence degree between them is low, determines the existence of a moving object. In the case of the on-vehicle camera, values of the Tx and Ty are often quite small, so that Tx/z, Ty/z and Txm, Tym may be omitted.

### Third Embodiment

The moving object detection apparatus according to a third embodiment will next be described. An on-vehicle camera having a visual field angle of 180° or a visual field angle exceeding 180° like a fish-eye camera or camera using a convex mirror uses a nonlinear projection method and thus cannot detect a moving object with a method that performs analysis on the assumption that a linear plane is employed.

Thus, the third embodiment aims to detect a moving object even using a nonlinear image taken by a camera having a wide angle imaging range.

In the block diagram of FIG. 1 illustrating the configuration of the moving object detection apparatus 100, the moving object detection unit 10 processes images taken using the camera 30 mounted on the vehicle 1 to detect a moving object and displays the detection result on the display unit 40.

The camera 30, which is, e.g., a super-wide-angle camera, such as a fish-eye lens camera, having a visual field angle exceeding 180°, is mounted on the vehicle 1 and takes an image around the vehicle 1. FIG. 1 illustrates an example in which the plurality of cameras 30 are mounted on the vehicle 1, each of which is disposed on the front side, rear side, or the like of the vehicle 1. Hereinafter, a case where a fish-eye lens camera (fish-eye camera) is used as the camera 30 will be described.

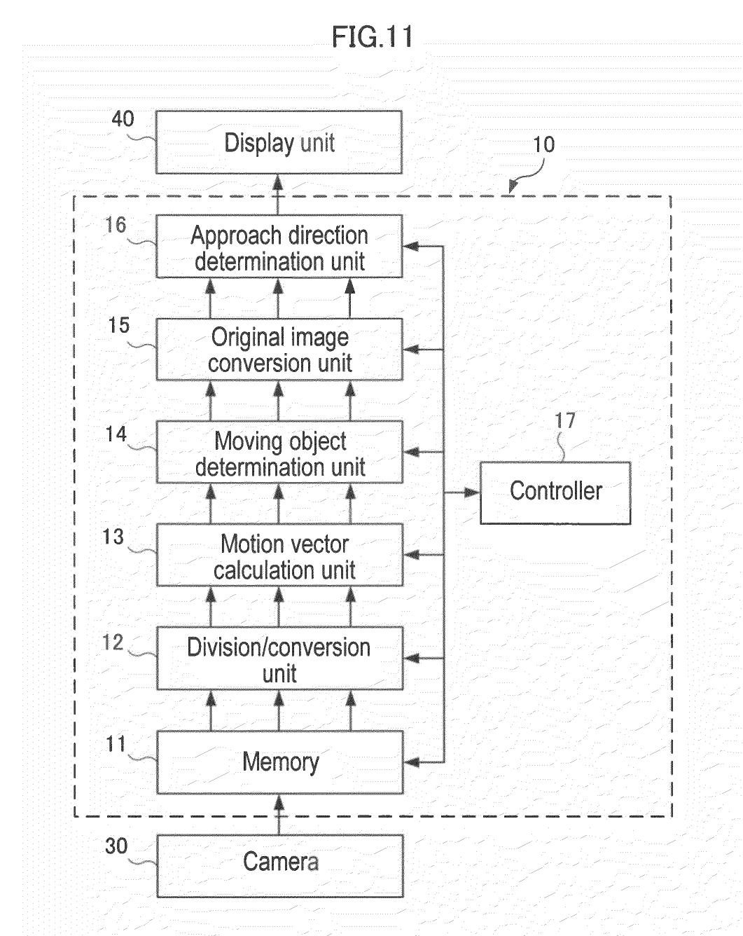

FIG. 11 is a block diagram illustrating a detailed configuration of the moving object detection unit 10. The moving object detection unit 10 includes a memory 11, a division/conversion unit 12, a motion vector calculation unit 13, a moving object determination unit 14, an original image conversion unit 15, an approach direction determination unit 16, and a controller 17.

Functions and operations of the above components of the moving object detection unit 10 will be described. The controller 17 is a microprocessor including a CPU, a ROM, a RAM, and the like and controls the operations of the above components (memory 11, division/conversion unit 12, motion vector calculation unit 13, moving object determination unit 14, original image conversion unit 15, and approach direction determination unit 16) of the moving object detection unit 10 according to a program stored in the ROM.

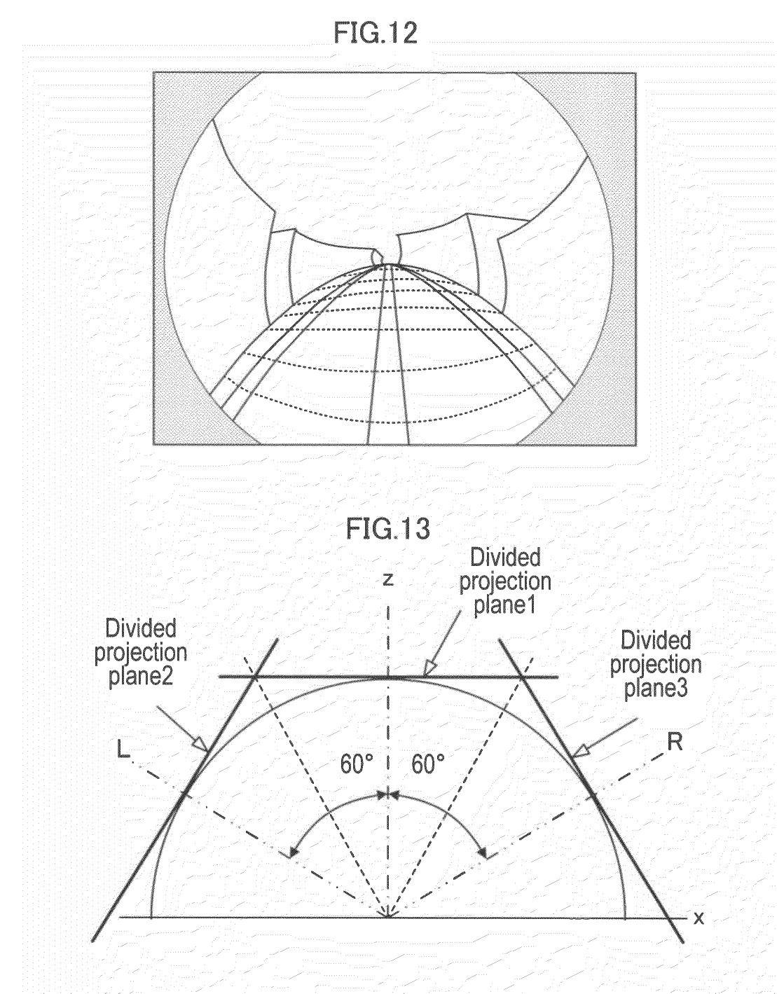

The camera 30, which has an imaging range of 180° or more, takes an image projected on the imaging surface in a nonlinear manner and writes an imaging signal into the memory 11. The image (camera image) taken by the camera 30 is a non-linear image as illustrated in FIG. 12. FIG. 13 is a plan view illustrating the imaging range of the camera 30.

The division/conversion unit 12 divides the taken image into three viewing angle ranges to generate divided projection plane images as illustrated in FIG. 13. As a camera coordinate system, an xyz coordinate system is defined, in which the optical axis of the camera 30 is set to z-axis, axis parallel to the road surface is set to x-axis, and axis on the plane perpendicular to the road surface is set to y-axis (in FIG. 13, y-axis is perpendicular to the paper surface).

As illustrated in FIG. 13, the non-linearly projected imaging surface (image as illustrated in FIG. 12) of the camera is placed on a plane in which z=0, and three divided projection planes 1, 2, and 3 which contact a semicircle having a radius corresponding to a focal length f are assumed. These three divided projection planes 1, 2, and 3 can be regarded as images taken by three virtual cameras. That is, the three virtual cameras have a common camera center O (0, 0, 0) and have optical axes thereof on a plane in which y=0. The center virtual camera has the same optical axis z as that of the camera 30. The optical axes L and R of the left and right virtual cameras are inclined with respect to the optical axis z of the center virtual camera by ±60°.

In the example of FIG. 13, the three virtual cameras each cover a visual field angle of 60°+α° (a means some overlap). Thus, the three virtual cameras serve as a pin-hole camera having a common camera center (O) and different optical axis angle.

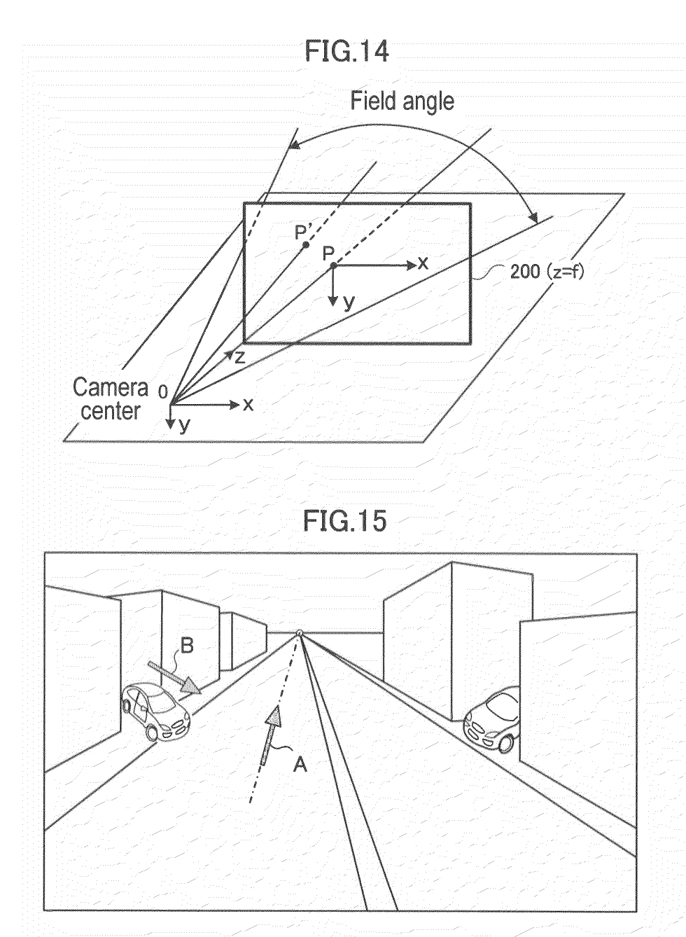

FIG. 14 is an explanatory view illustrating a pin-hole camera model. In FIG. 14, reference numeral 200 denotes a projected plane in which z=f (f is focal point), and pixels at given points on the projected plane 200 are represented by P and P′. The field angle is 60°±α°.

In each virtual camera, points on the imaging surface (y=0) and points on the projected plane one-to-one correspond to each other within a range of the visual field angle of 60°+α°. This correspondence can be calculated from a numerical expression that determines a projection method of the camera 30. Further, a previously calculated correspondence may be retained as a conversion table (LUT: look up table). The conversion table (LUT) is a table used for correcting distortion of a non-linear camera-taken image. Based on the conversion table, camera-taken data is converted into a linear projected plane image.

The division/conversion unit 12 performs the following conversion processing. That is, the division/conversion unit 12 selects and reads out, from image information of the camera 30 stored in the memory 11, image information corresponding to 60° of the center portion and uses the conversion table (LUT) to convert the read out image information into a center portion plane image. Similarly, the division/conversion unit 12 selects image information corresponding to 60° of the left and right portions and uses the conversion table (LUT) to convert the selected image information into a left portion plane image and a right portion plane image, respectively.

The motion vector calculation unit 13 calculates motion vectors of the above three plane images.

As the motion vector calculation processing, a known method such as a block matching method, a gradient method, or the like can be used. As is known, in the pin-hole camera model (FIG. 5) having a focal length f, a motion vector (u,v)T of the stationary object on a projected plane x-y generated in association with camera movement is represented by the following expression.

[Numeral 11]

U=(xy/f)Rx−(f²+x²)(1/f)R_{y}+yR_{z}+xT/z−fTₓ/z

v=(f²+y²)(1/f)Rₓ−xy/fR_{y}−xR_{z}+yT_{z}−fT_{y}/z (15)

In this expression, Rx, Ry, and Rz represent vehicle rotational components around the x-axis, y-axis, and z-axis, respectively, and Tx, Ty, and Tz represent the translational components in the x-axis direction, y-axis direction, and z-axis direction, respectively.

Further, x and y represent pixel positions on the image plane, and z represents a distance from the camera to object. From the above expression, the motion of the image associated with the movement of the vehicle (camera 30) is determined.

When the motion vector (u,v) of a given point P (x,y) on the image can be determined, and the vehicle movement parameters can be calculated in some way, the motion of the stationary object can be predicted. When the prediction is correct, the existence of a stationary object can be determined, while the prediction is incorrect, the existence of a moving object can be determined. Thus, by performing analysis based on the above expression, the motions peculiar to the stationary object and moving object associated with the movement of the vehicle can be determined.

The moving object determination unit 14 detects moving objects on the three planes from the motion vectors of the three plane images by linear prediction determination. For example, assume in the center portion plane image illustrated in FIG. 15 that the motion direction of the vehicle is A. In this case, an object (e.g., a vehicle coming from the lateral direction) representing a motion direction B different from the motion direction A, if exists, is determined to be a moving object. Various methods are available for determination of the moving object.

The determination result concerning the moving object by the moving object determination unit 14 is superimposed on the original camera image in the original image conversion unit 15. Thus, in the resultant original camera-taken image, objects existing over a plurality of the divided projection plane images can be recognized as one moving object that moves continuously.

The approach direction determination unit 16 determines the movement direction from the motion vector of the moving object and determines presence/absence of approach to the vehicle. When there is a moving object highly likely to approach the vehicle, the approach direction determination unit 16 generates image information for alarm that is visually recognizable by a driver and outputs the image information to the display unit 40. The alarm image includes information, e.g., an arrow representing the approach direction of the moving object. Thus, it is possible to appropriately notify a driver of information that any moving object, such as another vehicle or a pedestrian, that is approaching the vehicle from the front or rear direction, if there exists, by using the display unit 40.

### Fourth Embodiment

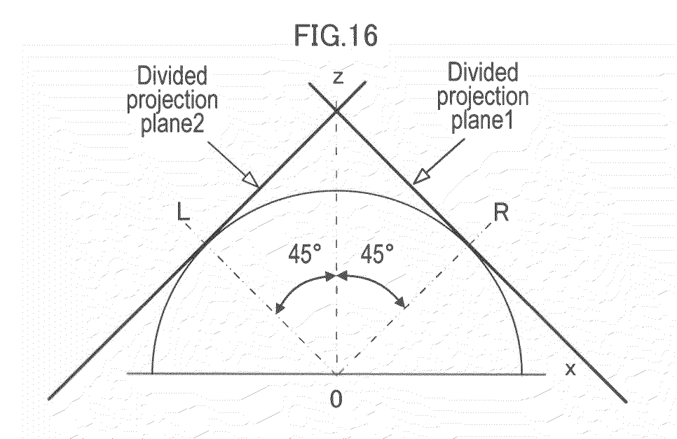

A fourth embodiment will next be described. The fourth embodiment is featured in the operation of the division/conversion unit 12. More specifically, the division/conversion unit 12 divides the image taken by the camera 30 into two viewing angle ranges to generate divided projection plane images. That is, as illustrated in FIG. 16, two virtual cameras having a common camera center O and having divided projection planes 1 and 2 contacting a semicircle having a radius corresponding to a focal length f are assumed. In FIG. 16, left and right virtual cameras having optical axes L and R inclined with respect to the optical axis z of the camera 30 by ±45° are assumed.

The same processing as in the third embodiment is performed with the three planes of FIG. 13 by two planes, and the motion vector calculation unit 13 calculates motion vectors of the above two plane images. The moving object determination unit 14 detects moving objects on the two planes from the motion vectors of the two plane images. The original image conversion unit 15 superimposes the determination result concerning the moving object by the moving object determination unit 14 on the original camera image. The approach direction determination unit 16 determines the movement direction from the motion vector of the moving object and determines presence/absence of approach to the vehicle.

According to the embodiments described above, by converting an image taken by a wide-angle camera such as a fish-eye camera into a plurality of divided projection plane images, it is possible to determine existence of a moving object based on the motion vector and to determine the direction of the moving object so as to notify a driver of approach to his or her vehicle, thereby avoiding danger.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An apparatus for detecting a moving object, comprising:
an image input unit that inputs a camera image taken by an on-vehicle camera;
a motion vector generation unit that processes the image from the image input unit to generate motion vectors of a plurality of points P in the image;
an estimation unit that estimates rotational components (Rx, Ry, Rz) of vehicle movement parameters as being equal to the inclination from each point P to a vanishing point when the inclination of the motion vector of each point P is corrected by the rotational components (Rx, Ry, Rz) of the vehicle movement parameters; and
a determination unit that corrects the inclination of the motion vector of a given point Q in the image by using the rotational components (Rx, Ry, Rz) of the vehicle movement parameters, compares the corrected inclination of the motion vector and inclination of a straight line connecting the given point Q and vanishing point, and detects the existence of a moving object that moves in a direction different from the vehicle movement direction when the coincidence degree between the inclinations is low, while detects the existence of a stationary object or a moving object that radially moves toward the vanishing point when the coincidence degree of the inclinations is high.

2. The apparatus according to claim 1, wherein
when the rotational component=0, the vehicle movement parameter estimation unit updates the vanishing point with the intersection of the extended lines of the motion vectors of the plurality of points P.

3. The apparatus according to claim 1, comprising:
a stationary area candidate estimation unit that estimates a stationary object area based on the motion vectors of the plurality of points P in the image, wherein
the vehicle movement parameter estimation unit estimates the rotational components (Rx, Ry, Rz) of the vehicle movement parameters based on the motion vectors of the plurality of points P in the estimated stationary object area image and the vanishing point.

4. The apparatus according to claim 3, wherein
the stationary area candidate estimation unit calculates the rotational component Ry (or rotational components Ry and Rz) corresponding to the rudder angle of the vehicle based on the motion vectors of the plurality of points P in the estimated stationary object area image and the vanishing point and selects an area near the peak of a histogram concerning the rotational component Ry (or rotational components Ry and Rz) of each point P as a stationary object area candidate.

5. The apparatus according to claim 3, comprising a translational direction moving object detection unit that inputs thereto image information that has not been detected as a moving object in the moving object detection unit, calculates a translational component Tz/z of the vehicle movement parameter from the motion vector of a given point Q in the stationary object area candidate and rotational components (Rx, Ry, Rz), sets an estimated distance weighting coefficient z0 that associates the road surface with camera viewing angle, compares a translational component z0(Tz/z) obtained by multiplying the (Tz/z) by the coefficient z0 and an estimated vehicle translational component Tzm, and detects the existence of a moving object when the coincidence degree between the z0(Tz/z) and Tzm is low.

6. The apparatus according to claim 5, wherein
the translational direction moving object detection unit calculates the translational component Tz/z of the vehicle movement parameter from the motion vectors of the plurality of points P in the stationary object area candidate and rotational components (Rx, Ry, Rz) and sets the average of the translational component z0(Tz/z) obtained by multiplying the (Tz/z) by the coefficient z0 as the estimated vehicle translational component Tzm.

7. The apparatus according to claim 5 or claim 6, wherein
the translational direction moving object detection unit previously sets a correspondence between a pixel position of the camera image and a distance between the road surface and camera as the estimated distance weighting coefficient z0.

8. An apparatus for detecting a moving object, comprising:
an image input unit that inputs a camera image taken by an on-vehicle camera;
a motion vector generation unit that processes the image from the image input unit to generate a motion vector of the image;
an estimation unit that calculates motion vectors of a plurality of points P in the image and a vanishing point at which extended motion vectors obtained by extending the motion vectors converge, and estimates rotational components (Rx, Ry, Rz) and a translational component as vehicle movement parameters based on the motion vectors and the vanishing point; and
a determination unit that sets an estimated distance weighting coefficient z0 that associates the road surface with camera viewing angle, calculates an estimated vehicle translational component from the average of a translational component obtained by multiplying the estimated translational component by the coefficient z0, predicts a motion vector of a given point Q in the image from the rotational components (Rx, Ry, Rz), translational component, and coefficient z0, compares the predicted motion vector and an actual measurement motion vector, and determines the existence of a moving object when the coincidence degree between the predicted motion vector and actual measurement motion vector is low.

9. The apparatus according to claim 8, wherein
a correspondence between a pixel position of the camera image and a distance between the road surface and camera is previously set as the estimated distance weighting coefficient z0.

10. A method for detecting a moving object, comprising:
inputting a camera image taken by an on-vehicle camera;
processing the image to generate motion vectors of a plurality of points P in the image;
estimating rotational components (Rx, Ry, Rz) of vehicle movement parameters as being equal to the inclination from each point P to a vanishing point when the inclination of the motion vector of each point P is corrected by the rotational components (Rx, Ry, Rz) of the vehicle movement parameters; and
correcting the inclination of the motion vector of a given point Q in the image by using the rotational components (Rx, Ry, Rz) of the vehicle movement parameters, comparing the corrected inclination of the motion vector and inclination of a straight line connecting the given point Q and the vanishing point, and detecting the existence of a moving object that moves in a direction different from the vehicle movement direction when the coincidence degree between the inclinations is low, while detecting the existence of a stationary object or a moving object that radially moves toward the vanishing point when the coincidence degree of the inclinations is high.

11. The method according to claim 10, wherein
when the rotational component is 0, the vanishing point is updated with the intersection of the extended lines of the motion vectors of the plurality of points P.

12. The method according to claim 10, comprising:
estimating a stationary object area based on the motion vectors of the plurality of points P in the image, wherein
the rotational component Ry (or rotational components Ry and Rz) corresponding to the rudder angle of the vehicle is calculated based on the motion vectors of the plurality of points P in the estimated stationary object area image and vanishing point, and
an area near the peak of a histogram concerning the rotational component Ry (or rotational components Ry and Rz) of each point P is selected as a stationary object area candidate.

13. The method according to claim 12, comprising:
inputting thereto image information that has not been detected as a moving object;
calculating a translational component Tz/z of the vehicle movement parameter from the motion vector of a given point Q in the stationary object area candidate and rotational components (Rx, Ry, Rz);
setting an estimated distance weighting coefficient z0 that associates the road surface with camera viewing angle, comparing a translational component z0(Tz/z) obtained by multiplying the (Tz/z) by the coefficient z0 and an estimated vehicle translational component Tzm, and detecting the existence of a moving object when the coincidence degree between the z0(Tz/z) and Tzm is low.

14. The method according to claim 13, wherein
the translational component Tz/z of the vehicle movement parameter is calculated from the motion vectors of the plurality of points P in the stationary object area candidate and the rotational components (Rx, Ry, Rz), and the average of the translational component z0(Tz/z) obtained by multiplying the (Tz/z) by the coefficient z0 is set as the estimated vehicle translational component Tzm.

15. A method for detecting a moving object, comprising:
inputting a camera image taken by an on-vehicle camera;
processing the image to generate motion vectors of a plurality of points P in the image and calculating a vanishing point at which extended motion vectors obtained by extending the motion vectors converge, and estimating rotational components (Rx, Ry, Rz) and a translational component as vehicle movement parameters based on the motion vectors and the vanishing point; and
setting an estimated distance weighting coefficient z0 that associates the road surface with camera viewing angle, calculating an estimated vehicle translational component from the average of a translational component obtained by multiplying the estimated translational component by the coefficient z0, predicting a motion vector of a given point Q in the image from the rotational components (Rx, Ry, Rz), translational component, and coefficient z0, comparing the predicted motion vector and an actual measurement motion vector, and determining the existence of a moving object when the coincidence degree between the predicted motion vector and actual measurement motion vector is low.

16. An apparatus for detecting a moving object, comprising:
a division/conversion unit that divides a non-linear image taken by an on-vehicle camera having a wide imaging range into a plurality of images each having a preset viewing-angle range to generate a plurality of linear projection plane images having a common camera center;
a calculation unit that calculates motion vectors of the projection plane images;
a determination unit that analyzes the motion vectors of the plurality of projection plane images to determine the existence of a moving object; and
a display unit that displays the determination result of the moving object determination unit.

17. The apparatus according to claim 16, wherein
the division/conversion unit divides a wide-angle camera image having a viewing angle exceeding 180° into a plurality of images each having a viewing angle not more than 180° including an overlap portion to generate a plurality of projecting plane images.

18. The apparatus according to claim 16, wherein
the moving object determination unit determines presence/absence of a moving object approaching the vehicle based on the directions of the motion vectors calculated in the motion vector calculation unit.

19. The apparatus according to claim 16, comprising:
an original image conversion unit that superimposes the determination result of the moving object determination unit on a taken image before division; and
an approach direction determination unit that determines the approach direction of the moving object based on the image obtained in the original image conversion unit and displays image information representing the approach of the moving object on the display unit.

20. A method for detecting a moving object, comprising:
dividing a non-linear image taken by an on-vehicle camera having a wide imaging range into a plurality of images each having a preset viewing-angle range to generate a plurality of linear projection plane images having a common camera center;
calculating motion vectors of the projection plane images;
analyzing the motion vectors of the plurality of projection plane images to determine the existence of a moving object; and
displaying the determination result of the moving object existence on a display unit.

21. The method according to claim 20, wherein
presence/absence of a moving object approaching the vehicle is determined based on the directions of the calculated motion vectors.

22. The method according to claim 20, comprising:
superimposing the determination result into an original image before division;
determining the approach direction of the moving object based on the original image on which the determination result is superimposed; and
displaying image information representing the approach of the moving object on the display unit.
